(19) United States
(12) Patent Application Publication
(10) Pub. No.: US 2026/0322784 A1
(43) Pub. Date: Oct. 15, 2026

(54) ASSOCIATION IDENTIFIER ASSIGNMENT FOR PRIVACY ENHANCEMENT STATIONS

(71) Applicant: Cisco Technology, Inc., San Jose, CA (US)

(72) Inventors: Javier I. CONTRERAS ALBESA, Sant Cugat del Valles (ES); Ugo M. CAMPIGLIO, Morges (CH); Federico LOVISON, Fontanelle (IT); Domenico FICARA, Essertines-Sur-Yverdon (CH); Jerome HENRY, Pittsboro, NC (US)

(21) Appl. No.: 19/176,101

(22) Filed: Apr. 10, 2025

Related U.S. Application Data
(60) Provisional application No. 63/666,124, filed on Jun. 29, 2024.

(51) Int. Cl. H04L 61/5092; H04W 76/10

(52) U.S. Cl. CPC H04L 61/5092; H04W 76/10

(57) ABSTRACT

The present disclosure provides techniques for AID generation for enhanced data privacy (EDP) operations. An AP provides a first communication indicating that the AP supports a randomized MAC address rotation management protocol. The AP establishes a communications link between the AP and a STA, where establishing the communications link comprises assigning the STA to an EDP group. The AP generates a list of N AIDs for the STA, each of the N AIDs to be used in a corresponding epoch of N epochs associated with the EDP group. The AP transmits, to the STA in a protected wireless frame, information indicating the list of N AIDs for the STA. The AP maintains the communications link with the STA based at least in part on the timing information for randomized MAC address rotation for the EDP group, and including using each AID in the list of N AIDs during corresponding epochs.

### CROSS-REFERENCE TO RELATED APPLICATIONS

This application claims benefit of co-pending U.S. provisional patent application Ser. No. 63/666,124 filed Jun. 29, 2024. The aforementioned related patent application is herein incorporated by reference in its entirety.

### TECHNICAL FIELD

Embodiments presented in this disclosure generally relate to wireless communication. More specifically, embodiments disclosed herein relate to generation and assignment of association identifiers (AIDs) in enhanced data privacy (EDP) operations.

### BACKGROUND

Wireless communication networks, such as Wi-Fi, rely on various identifiers to manage device activities and facilitate communication between access points (AP) and stations (STAs). However, these identifiers can be exploited by attackers to track devices, monitor user activity, and conduct privacy-invasive operations. Attackers can collect and analyze these identifiers over time, linking a device's past and present network activity. Common identifiers that can be tracked include the media access control (MAC) addresses, association identifiers (AIDs), and sequence numbers in frame headers.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 depicts an example AID Assignment frame including AIDs generated by an AP, according to some embodiments of the present disclosure.

FIG. 2 depicts example formats of an AID List Value field, including a full list format and a delta encoding format, according to some embodiments of the present disclosure.

FIG. 3 depicts an example of AID assignment where an AP generates AIDs for STAs in each epoch following two no-collision rules, according to some embodiments of the present disclosure.

FIG. 4 depicts an example of AID assignment where an AP generates AIDs for STAs using a block-based selection mechanism, according to some embodiments of the present disclosure.

FIG. 5 depicts an example of AID assignment where an AP generates AIDs for STAs using a matrix-based selection mechanism, according to some embodiments of the present disclosure.

FIG. 6 depicts an example AID Assignment frame including hash function parameters for AID computation, according to some embodiments of the present disclosure.

FIG. 7 depicts an example method for an AP to assign AIDs to STAs using a structured AID assignment scheme based on direct AID generation, according to some embodiments of the present disclosure.

FIG. 8 depicts an example method for an AP to assign AIDs to STAs using a structured AID assignment scheme based on a perfect hash function, according to some embodiments of the present disclosure.

FIG. 9 is a flow diagram depicting an example method for AID generation and assignment, according to some embodiments of the present disclosure.

FIG. 10 depicts an example network device configured to perform various aspects of the present disclosure, according to some aspects of the present disclosure.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure provides a method, including generating, by an access point (AP), a set of association identifiers (AIDs) for a plurality of stations (STAs) connected to the AP in a wireless network, where each STA is assigned a unique AID within an epoch according to a structured AID assignment scheme, determining, by the AP, an AID sharing mechanism to transmit a list of assigned AIDs to a respective STA among the plurality of STAs, where the respective STA applies the assigned AIDs in one or more subsequent epochs, and transmitting, by the AP to the respective STA, an AID Assignment frame comprising the list of assigned AIDs.

Other embodiments in this disclosure provide one or more non-transitory computer-readable media containing, in any combination, computer program code that, when executed by operation of a computer system, performs operations in accordance with one or more of the above methods, as well as a system of a network device comprising one or more computer processors, and one or more memories collectively containing one or more programs, which, when executed by the one or more computer processors, perform operations in accordance with one or more of the above methods.

### EXAMPLE EMBODIMENTS

Enhanced Data Privacy (EDP) has been introduced to prevent attackers from tracking devices based on fixed identifiers commonly used in wireless communication networks. EDP involves dynamically updating identifiers at defined epochs to anonymize the device's identity. Such periodic changes improve privacy by making it difficult for an attacker to correlate a device's presence across different time intervals.

Common identifiers that can be tracked include the MAC address, AID, sequence numbers in frame headers, and other protocol-specific identifiers that are used across multiple transmissions. Among these, the AID is one of the most easily trackable identifiers. The AID is assigned to a station (STA) during the association phrase with a Basic Service Set Identifier (BSSID) and is used across various functionalities, including preamble encoding, delivery traffic indication map (DTIM) information, power saving (PS)-poll, and very high throughput (VHT) transmission opportunity (TXOP) for power-saving clients. Additionally, AID values are utilized in several other protocol-specific mechanisms within IEEE 802.11 networks, further increasing their exposure.

AIDs are particularly vulnerable to tracking for two main reasons. First, AIDs are transmitted in the clear and unencrypted format within various 802.11 headers and payloads, making them easily observable by third parties. Since these identifiers are not encrypted, an attacker can passively monitor wireless traffic and extract AID values without requiring active participation in the network. Second, AIDs are assigned from a small pool of values, typically 11-bit (around 2000 values), with some protocol-specific scenarios allowing 12-bit or 13-bit AIDs. Even with the largest AID size, the total pool of possible AIDs remains small compared to a random MAC address space, which can be up to 46 bits (out of 48-bit MAC address space. This limited address space makes it feasible for attackers to correlate AIDs across different frames and track devices over time.

Frames and procedures used in EDP are being defined in IEEE 802.11bi to improve station privacy and prevent device tracking based on persistent identifiers. One potential approach involves updating parameters such as the MAC address and AID at defined time intervals, referred to as “epochs.” However, if the same AID is used consistently across different epochs, an adversary can correlate these addresses and enables long-term tracking of the device. Such correlation contradicts the privacy objectives of IEEE 802.11bi and similar wireless standards.

To enhance privacy while maintaining network efficiency, the AID assignment mechanism for IEEE 802.11bi (or another wireless standard) may need to meet several criteria. First, an AID should not be used consistently by the same STA across two consecutive epochs, as this would enable an adversary to link identifiers and correlate the device's network activity, even when MAC randomization is applied. Second, STAs associated with a single BSSID should not be able to predict the AID that another STA in the same BSSID will use in the next epoch. This is to prevent internal privacy risks where a device could infer another device's future AID assignment. Third, there should be no AID collisions among STAs within a BSSID, as such collisions can negatively impact network performance and power-saving mechanisms. Fourth, AID assignment should be time-deterministic, where the time required to determine the AIDs remains fixed and does not introduce variations (which could otherwise disrupt traffic flow). Finally, AID assignment should maintain backward compatibility, allowing legacy devices to coexist in the same channel, where AIDs are typically assigned from an 11-bit space (e.g., approximately 2000 values).

Embodiments of the present disclosure provide systems, methods, and apparatuses for AID generation and assignment that satisfy these five privacy criteria and enable efficient AID management in EDP.

In one embodiment, the AP is configured to manage AID assignment, utilizing its centralized role to distribute AIDs among connected STAs in the same BSSID. In this embodiment, the AP may directly select AIDs for each station from the available pool (e.g., 11-bit space, approximately 2000 values) while following the five privacy goals. Since the AP is aware of the AIDs assigned to each STA, it can actively prevent AID collisions, assigning each STA a unique AID within an epoch, and preventing repeated AIDs across two consecutive epochs. Additionally, since AP has full control over AID assignment, STAs have no visibility into the allocation process and cannot predict the AID assigned to other STAs in the same BSSID.

In another embodiment, to further prevent collisions between consecutive epochs, such as that different STAs cannot reuse the same AIDs across two consecutive epochs (e.g., if STA 1 is assigned AID 1 in epoch 1, AID 1 cannot be assigned to any other STAs in the same BSSID in epoch 2), a block-based AID assignment approach is used. In this embodiment, the AP selects AIDs from structured blocks in each epoch, so that AIDs assigned in one epoch are drawn from a different non-overlapping range in the next epoch (e.g., AP selecting AID for epoch 1 from the range of 1-100, and selecting AIDs for epoch 2 from the range of 101-200). This approach mitigates issues in the Traffic Identification Map (TIM) frames, particularly for power-saving STAs. Power-saving STAs may enter sleep mode and rely on buffered frames stored at the AP, with pending data indicated in the TIM field of Beacon frames. If AIDs (e.g., AID 1 is used by STA 1 in epoch 1 and used by STA 2 in epoch 2) are reused too quickly across consecutive epochs, it can cause buffer misidentification, where a STA's buffered frames from a previous epoch (e.g., epoch 1) may be incorrectly associated with a different STA assigned the same AID in a new epoch (e.g., epoch 2). By structuring AID assignment into non-overlapping blocks across epochs, this embodiment ensures that AIDs from one epoch do not immediately reappear in the next. This approach reduces ambiguity in TIM processing and maintains efficiency in power-saving mechanisms.

In another embodiment, the AP utilizes a permutation matrix to assign AIDs. The matrix includes columns representing epochs and rows representing STAs, with each column containing a unique permutation of AIDs to prevent collisions. This approach guarantees that AIDs do not repeat across consecutive epochs, each STA receives an AID in a deterministic manner, and no two STAs in the same epoch share the same AID. This embodiment provides a structured permutation approach for AID generation.

In the above disclosed embodiments, once AIDs are assigned, the AP may share this information with each STA. At least two approaches may be used for this transmission: full list encoding and delta encoding. In the full list encoding approach, the AP transmits a complete list of assigned AIDs for multiple epochs. This method provides full transparency and predictability but may result in higher overhead, especially when supporting a large number of STAs. Alternatively, in the delta encoding approach, instead of transmitting the entire AID list, the AP shares only the initial AID along with a sequence of delta values, where each delta value presents the offset from the previous AID. The delta encoding approach reduces transmission overhead while still enabling deterministic AID assignment.

Besides the above-discussed embodiments where the AP explicitly assigns AIDs to connected STAs, another embodiment involves using a perfect hash function, where the AP shares a function and its associated parameters instead of directly transmitting assigned AID lists. In this embodiment, each STA computes its own AID based on a large input domain (e.g., over-the-air (OTA) MAC address). This approach provides several advantages. First, AID uniqueness is guaranteed without collision due to the deterministic nature of perfect hash functions. Second, an STA cannot predict another STA's AID, preventing internal privacy risks. Third, brute-force attacks are mitigated because the input domain (e.g., OTA MAC address up to 46 bits) is significantly larger than the AID output range, making it infeasible for an attacker to precompute mappings. Finally, this approach improves security by eliminating the need to transmit AID lists over the air. In the above-discussed embodiments, if an adversary intercepts the AID Assignment frame, they could potentially extract the full list of assigned AIDs, allowing them to track multiple epochs. However, in the present embodiment, since no AID values are transmitted, an attacker cannot directly obtain or correlate the AID assignments of different STAs. Despite the benefits, one drawback of this embodiment is the significant overhead (e.g., O(N)) required to share the perfect hash function parameters. Since the hash function must be designed to guarantee a collision-free mapping of STAs to AIDs, the AP needs to transmit O(N) function parameters. Additionally, the computational complexity for STAs may increase, as each STA may locally compute its AID using the received parameters instead of simply reading a directly assigned value. This embodiment is useful in environments with strict privacy requirements.

In one embodiment, the assigned AIDs or hash function parameters may be transmitted using an AID Assignment frame. The AID Assignment frame may be a separate action frame or part of an extensible authentication protocol over local area network (LAN) (EAPOL) message 4 during the 4-way handshake process. In some embodiments, the AID Assignment frame is proactively transmitted by the AP to all connected STAs. In some embodiments, the AID Assignment frame is sent in response to a request from an STA.

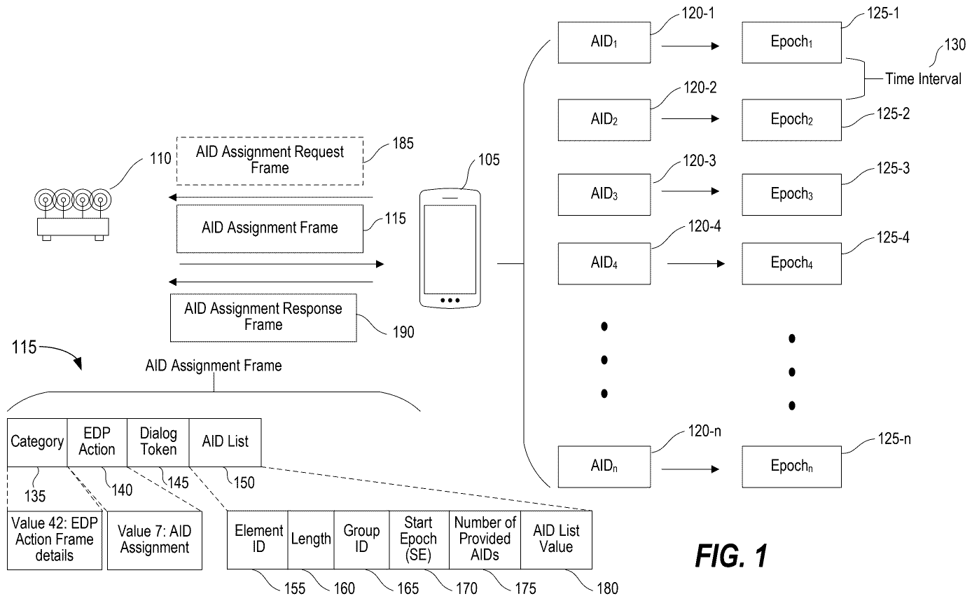

FIG. 1 depicts an example AID Assignment frame 115 including AIDs generated by an AP, according to some embodiments of the present disclosure.

As depicted, an AP 110 transmits an AID Assignment frame 115 to a connected STA 105. The AP 110 may refer to an AP multi-link device (MLD), a single-link AP, or any other type of wireless network device capable of managing AID assignment within a BSSID. The STA 105 may refer to a non-AP MLD, a single-link device, or another type of wireless station capable of establishing a connection with the AP 110.

As shown in FIG. 1, the AID Assignment frame 115 may be transmitted proactively or reactively. In a proactive transmission, the AP 110 sends the AID Assignment frame 115 without first receiving an AID assignment request 185 from STA 105. This approach reduces latency and minimizes unnecessary signaling. In another embodiment, in a reactive transmission, the AP 110 may send the AID Assignment frame 115 in response to an AID assignment request 185 from STA 105. Within the request 185, STA 105 may include information such as the STA's association status, storage limit, preferred update timing, and any other constraints to AID assignment.

In some embodiments, the AID Assignment frame may be a separate action frame or part of an extensible authentication protocol over local area network (LAN) (EAPOL) message 4 during the 4-way handshake process.

In some embodiments, upon receiving the AID Assignment frame 115, the STA 105 may send a response frame 190 to the AP 110, indicating the status of the received AIDs (e.g., the AIDs have been fully stored, partially stored, or rejected as being sent too early).

The AID Assignment frame 115, as depicted, includes a list of AIDs 120 generated by AP 110 and assigned to STA 105 for use in subsequent epochs 125. As shown, a total of N AIDs is assigned, with each AID corresponding to a specific epoch and being used sequentially. For example, AID₁ 120-1 is applied to Epoch₁ 125-1. AID₂ 120-2 is applied to Epoch₂ 125-2, and so on, with AIDₙ 120-n applied to Epochₙ 125-n. The pre-assignment of AIDs reduces signaling overhead, as STA 105 does not need to request a new AID for each epoch. In some embodiments, the list of AIDs may be represented in a full list format (where all AIDs are explicitly included), or in a delta encoding format (where only an initial AID is provided along with offset values to compute subsequent AIDs).

As depicted, the AID assignment frame 115 includes several fields that facilitate structured AID allocation. These fields include a Category field 135, an EDP Action field 140, a Dialog Token field 145, and an AID List element 150. The Category field 135 specifies the frame category. For an EDP action frame, a predefined value of 42 is included within the field to differentiate it from other types of action frames (e.g., Protected High Throughput (HT) Action frame, Protected Very High Throughput (VHT) Action frame). The EDP Action field 140 specifies the type of EDP action being performed. For AID assignment, this field is set to 7, distinguishing it from other EDP-related actions (e.g., EDP Group Parameter frames, EDP Epoch Request frames, EDP Epoch Response frames). The Dialog Token field 145 is set to a nonzero value to track request/response transactions between the AP 110 and STA 105. The AID List element 150 contains a sequence of AID values 120 assigned to the STA for use in next EDP epochs.

Within the AID List element 150, the following subfields are included: an Element ID field 155, a Length field 160, a Group ID field 165, a Start Epoch (SE) field 170, a Number of Provided AIDs field 175, and an AID List Value field 180. The Element ID field 155 includes values that identify the AID List Element 150 within the AID Assignment frame 115. The Length field 160 specifies the total length of the AID List element 150. The Group ID field 165 indicates the EDP group to which the STA belongs. As used herein, an EDP group includes a set of STAs that follow a common AID update policy. Within the group, each STA updates the AIDs periodically at predefined intervals to prevent long-term tracking. The AP 110 may advertise available EDP groups to connected STAs 105. Each available EDP may have specific epoch intervals and/or minimum storage requirements. A group with a larger epoch interval (e.g., 1 day) may have a lower storage size requirement, as longer intervals require few AID updates within the same period of time, reducing the total number of AIDs that need to be stored by the STA 105. The STA 105 may evaluate these parameters and send a request to join a suitable EDP group. Once STA 105 is accepted into an EDP group, AP 110 may assign AIDs to the STA 105 for use in upcoming epochs. Within the AID Assignment frame 115, the AP 110 uses the Group ID field 165 to indicate the group that STA has joined.

The SE field 170 defines the first epoch in which the assigned AIDs take effect. The Number of Provided AIDs specifies the total number of AIDs assigned in frame 115. The AID List Value field 180 contains the actual AID value assigned to the STA for use in different epochs. Each AID entry is stored in a fixed-length format (e.g., 11-bit values for standard AID assignment). The AIDs values are ordered sequentially, where each value corresponds to a specific contiguous epoch following the SE field. For example, when the AP assigns a total of N AID values, AID₁ 120-1 is used in Epoch₁ 125-1 (which is the Start Epoch), AID₂ 120-1 is used in Epoch₂ 125-2, and so on, with AIDₙ 120-n used in Epochₙ 125-n. The structure ensures that each AID value is applied in the correct chronological order without requiring STA to perform additional processing for mapping AIDs to specific epochs.

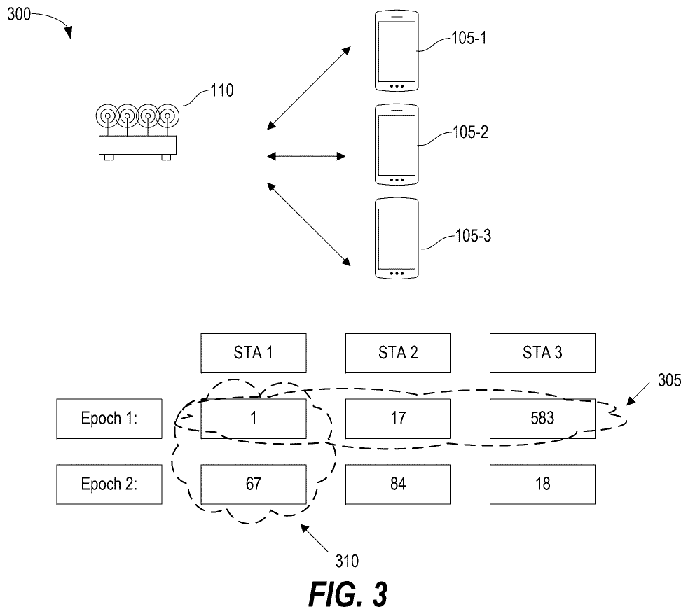

The assigned AIDs 120 may be generated by the AP following a structured AID assignment scheme, such as direct generation in compliance with no-collision rules, block-based selection, or matrix-based AID generation. More details about AID generation are discussed below with references to FIGS. 3-5.

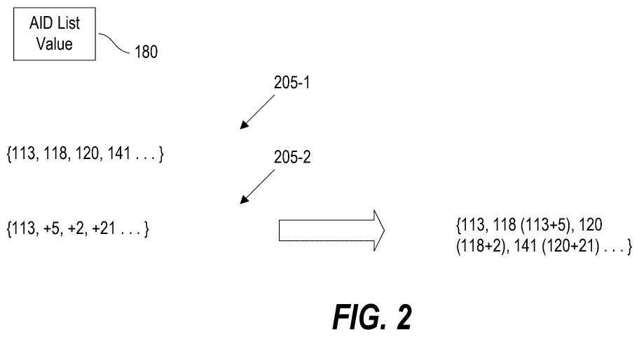

FIG. 2 depicts example formats 205 used within an AID List Value field, including a full list format 205-1 and a delta encoding format 205-2, according to some embodiments of the present disclosure. As discussed in FIG. 1, the AID List Value field 180 contains the actual AIDs assigned to the STA 105 and is arranged in a sequential manner. To convey the assigned AIDs, two formats may be used.

In the full list format 205-1, the AP 110 transmits a complete list of assigned AIDs for multiple epochs. Upon receiving the complete list, STA 105 may directly use them without additional computation. The AIDs are listed sequentially, with each entry corresponding to a specific epoch. For example, if AP 110 assigns AIDs to STA 105 for four consecutive epochs using the full list format, the AID list is as follows:
{113, 118, 120, and 141},

Upon receiving the full list, STA 105 directly applies AID 113 to epoch 1, AID 118 is applied to epoch 2, AID 120 is applied to epoch 3, and AID 141 is applied to epoch 4. The transmission of a full list allows the STA to directly use the provided AIDs without additional computation. However, the full list format may result in higher signaling overhead, particularly in embodiments where a large number of AIDs (e.g., 100) are assigned within a single frame.

To reduce transmission overhead, delta encoding format may be used. Instead of listing every AID, the AP 110 may transmit an initial AID (which serves as the starting reference) and a sequence of delta values, where each delta represents the incremental change from the previous AID. For example, if the same STA is assigned AIDs using delta encoding, the transmitted values may be as follows:
{113, +5, +2, +21}

Upon receiving the full list, STA 105 performs a computation before applying each AID. Here, AID 113 is the initial value and is directly applied to epoch 1. AID 118 is computed by adding 5 to 113 and is then applied to epoch 2. AID 120 is computed by adding 2 to 118 and is applied to epoch 3. AID 141 is computed by adding 21 to 120 and is applied to epoch 4. The provided example provides an initial AID along with incremental values to compute subsequent AIDs. In some embodiments, the delta values may include negative offsets for certain epochs. Additionally, the provided example specifies deltas relative to the previous epoch's AID. In some embodiments, the delta values may be computed relative to the initial AID across all epochs.

The delta encoding format 205-2 significantly reduces the size of the AID List Value subfield 180, as only one complete AID needs to be transmitted (the initial AID), and all other values are small deltas that require fewer bits to encode. However, this approach requires STA 105 to compute each subsequent AID based on the previous value, which increases computational complexity and processing overhead on the STA. Given this, the delta encoding format 205-2 is suitable for scenarios where minimizing transmission overhead is a priority, such as in high-density networks where the AP needs to manage AID assignment for a large number of STAs. The delta encoding format 205-2 is also beneficial in embodiments where STA devices have sufficient computational resources to perform incremental AID calculations without significant impact on performance. Conversely, in resource-constrained devices or environments where low-latency AID retrieval is desired, the full list encoding format 205-1 may be preferred to avoid additional computational burden on STAs.

As discussed above in FIG. 1, the AP 110 may send an AID Assignment frame to STA 105, providing a list of AIDs that the STA 105 will use in subsequent epochs. The AID List Value field 180 in the assignment frame may be formatted in either full list encoding or delta encoding, as illustrated in FIG. 2. FIGS. 3-5 further explore how the AP 110 generates AIDs for assignment.

FIG. 3 depicts an example of AID assignment where an AP generates AIDs for STAs in each epoch following two no-collision rules, according to some embodiments of the present disclosure.

As depicted, the AP 110 selects AIDs directly from an available pool of values for each STA 105 in every epoch. In an 11-bit AID space, this pool includes approximately 2000 possible values. Since the AP 110 has full control over AID assignment, the AP can maintain that no two STAs within the same epoch receive the same AID. Additionally, the AP 110 can prevent a single STA from being assigned the same AID across two consecutive epochs.

For example, as depicted in FIG. 3, AP 110 is connected to three STAs: STA 105-1, STA 105-2, and STA 105-3. In epoch 1, the AP assigns AID 1 to STA₁ 105-1, AID 17 to STA₂ 105-2, and AID 583 to STA₃ 105-3. In epoch 2, new AIDs are assigned, with AID 67 assigned to STA₁ 105-1, AID 84 assigned to STA₃ 105-3, and AID 18 to STA₃ 105-3. During AID assignment, the AP 110 ensures that no STA is assigned the same AID across two consecutive epochs (as depicted by 310) (e.g., STA 105-1 receives AID 1 in epoch 1 and AID 67 in epoch 2). Additionally, no two STAs in the same epoch share the same AID (as depicted by 305) (e.g., AIDs 1, 17, and 583 are assigned to different STAs in epoch 1). The no-collision rule across epochs prevents tracking of devices over time, and the no-collision rule within the same epoch eliminates conflicts in frame processing and network operation.

Furthermore, since the AP 110 retains full control over AID assignment (e.g., the AP 110 is the sole entity determining AID assignment), STAs 105 have no visibility into the allocation process. The AP 110 may assign AIDs independently for each STA, preventing any pattern-based prediction that could compromise privacy. The AID assignment is also time-deterministic, as the AP 110 computes the assigned AIDs within a fixed timeframe. This allows that each STA receives its AIDs without unpredictable delays.

Finally, since the AP assigns AIDs within the standard-defined range (e.g., 11-bit space, approximately 2000 values), legacy devices can still interpret and use these AIDs without modification. Therefore, the current embodiment for AID assignment achieves all five discussed goals—preventing AID reuse across epochs, preventing STA prediction of other STAs'AIDs, avoiding AID collision within an epoch, providing time-deterministic assignment, and maintaining backward compatibility—while enabling efficient AID transmission for subsequent epochs.

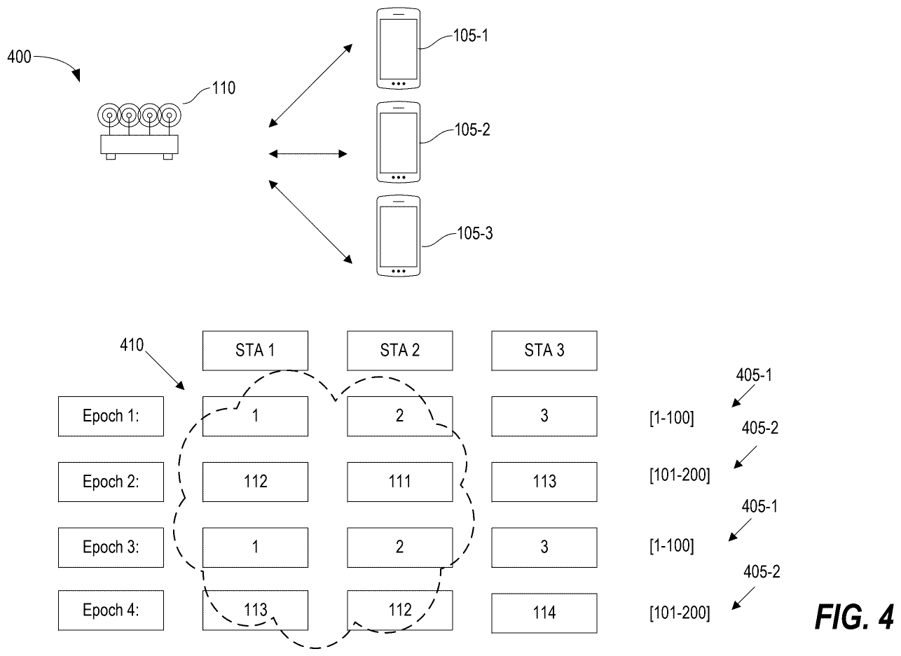

FIG. 4 depicts an example of AID assignment 400 where an AP generates AIDs for STAs using a block-based selection mechanism, according to some embodiments of the present disclosure.

As discussed in FIG. 3, while the AP 110 ensures that no two STAs 105 in the same epoch share the same AID, it does not prevent an AID assigned to one STA in epoch 1 from being reused by another STA in epoch 2. For example, AID 1 assigned to STA₁ 105-1 for epoch 1 could be reassigned to another STA in epoch 2. This reuse may cause issues in the TIM, particularly for power-saving STAs that rely on TIM to determine if they have buffered frames at the AP 110. If an STA (e.g., STA₁ 105-1) that was previously assigned a specific AID (e.g., AID 1) in epoch 1 later enters power-saving mode, but in epoch 2 that same AID (e.g., AID 1) is assigned to another STA (e.g., STA₂ 105-2), the AP's TIM bitmap may incorrectly signal buffered frames intended for the original STA (e.g., STA₁ 105-1) to the new STA (e.g., STA₂ 105-2). This may lead to frame misdelivery or unnecessary wake-ups.

To address this issue, FIG. 4 provides a method for selecting AID values from predefined blocks (e.g., selected from range 1-100 or range 101-200), preventing AIDs assigned in one epoch from overlapping with those in the next consecutive epoch (as depicted by 410). This block-based AID assignment effectively maintains structured AID allocation while mitigating TIM-related issues.

As depicted in FIG. 4, the AP 110 selects AIDs from a defined range (or block) for each epoch. In epoch 1, AIDs are selected from range 1-100 (as depicted by 405-1), with AID 1 assigned to STA₁ 105-1, AID 2 assigned to STA₂ 105-2, AID 3 assigned to STA₃ 105-3. In epoch 2, AIDs are selected from a different range, 101-200 (as depicted by 405-2), where STA₁ 105-1 is assigned AID 112, STA₂ 105-2 is assigned AID 111, and STA₃ is assigned AID 113. In epoch 3, the selection returns to the original range, 1-100 (as depicted by 405-1), and follows the same structured assignment patterns, with AID 1 assigned to STA₁ 105-1, AID 2 assigned to STA₂ 105-2, AID 3 assigned to STA₃ 105-3. In epoch 4, AIDs are once again selected from the 101-200 range (as depicted by 405-2), with AID 113 assigned to STA₁ 105-1, AID 112 assigned to STA₂ 105-2, AID 114assigned to STA₃ 105-3. The depicted example is provided for conceptual clarity. In some embodiments, in epochs 3 and 4, AP 110 may select AIDs from a new range instead, such as 201-300.

The block-based assignment prevents AID reuse by different STAs across consecutive epochs, providing that an AID assigned in one epoch is not reassigned to another STA in the next epoch. However, the same AID may be reused by the same STA in non-consecutive epochs (e.g., STA 105-1 receiving AID 1 in both epoch 1 and epoch 3).

Beyond the additional advantage of preventing different STAs from reusing the same AID across two consecutive epochs, the block-based AID assignment also satisfies the five discussed goals. First, since AIDs are selected from different non-overlapping blocks in consecutive epochs, an STA's AID from the previous epoch cannot appear in the next epoch and prevents cross-epoch tracking. Second, although the block-based assignment follows a structured approach, STAs 105 still cannot predict specific AID assignments for other STAs within the block. The AP dynamically manages assignment within each predefined range. Even within a given block (or range), AID allocation remains unpredictable to individual STAs. Third, the AP's controlled selection guarantees that no AID collisions occur within the same epoch—no two STAs receiving the same AID during an epoch. Fourth, the AID assignment remains time-deterministic, allowing the AP 110 to allocate AIDs within a fixed timeframe. Finally, since the AP 110 assigns AIDs within the standard-defined AID range (e.g., 11-bit space, approximately 2000 values), legacy devices can still interpret and use these AIDs without modifications. This guarantees that the block-based AID assignment remains fully backward compatible with existing IEEE 802.11 networks.

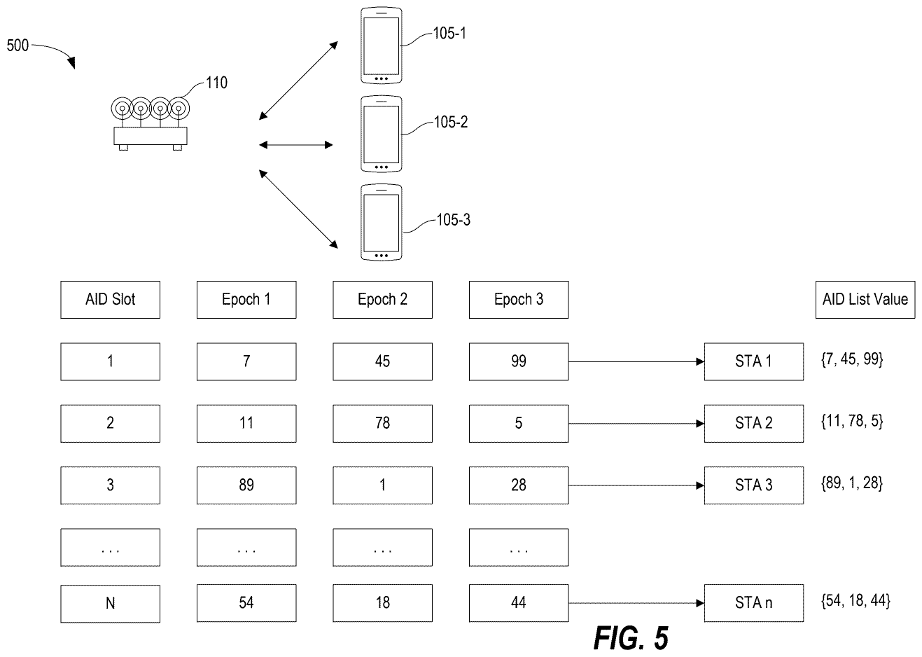

FIG. 5 depicts an example of AID assignment 500 where an AP generates AIDs for STAs using a matrix-based selection mechanism, according to some embodiments of the present disclosure.

As depicted, the AP 110 constructs a matrix where each column represents an epoch, and each row represents an STA. Each column is populated with a permutation of AIDs from the available pool (e.g., 11-bit space, approximately 2000 values). For example, as depicted in FIG. 5, the first column corresponds to epoch 1, containing the precomputed sequence {7, 11, 89, . . . 54}. Since each row corresponds to a specific STA, here, AID 7 is assigned to STA₁ 105-1, AID 11 is assigned to STA₂, AID 89 is assigned to STA₃ 105-3, and so on, with AID 54 being assigned to STAₙ 105-n. In epoch 2, the AP 110 assigns AIDs from column two, which contains a different permutation of values {45, 78, 1, . . . 18}. Similarly, in epoch 3, the AP selects AIDs from column three, which includes another permutation of values {99, 5, 28, . . . 44}. As a result, STA₁ 105-1 receives a set of AIDs for the next three epochs, including {7, 45, 99}, STA₂ 105-2 receives {11, 78, 5}, STA₃ 105-3 receives {89, 1, 28}, and so forth, with STAₙ 105-n receives {54, 18, 44}.

The matrix-based approach is similar to the block-based assignment in that it prevents different STAs from reusing the same AID across two consecutive epochs. Additionally, because each epoch's AID assignments are from a permutation, no STA receives the same AID it had in the previous epoch. This mitigates long-term tracking risk and maintains the unpredictable nature of AID assignment (e.g., one STA cannot predict another STA's AID). Additionally, since each column represents a fully independent permutation, no two STAs in the same epoch share the same AID and therefore prevent intra-epoch collisions. The matrix-based AID generation method balances randomness and structure, providing unique AID assignment across epochs while preventing predictability and collisions.

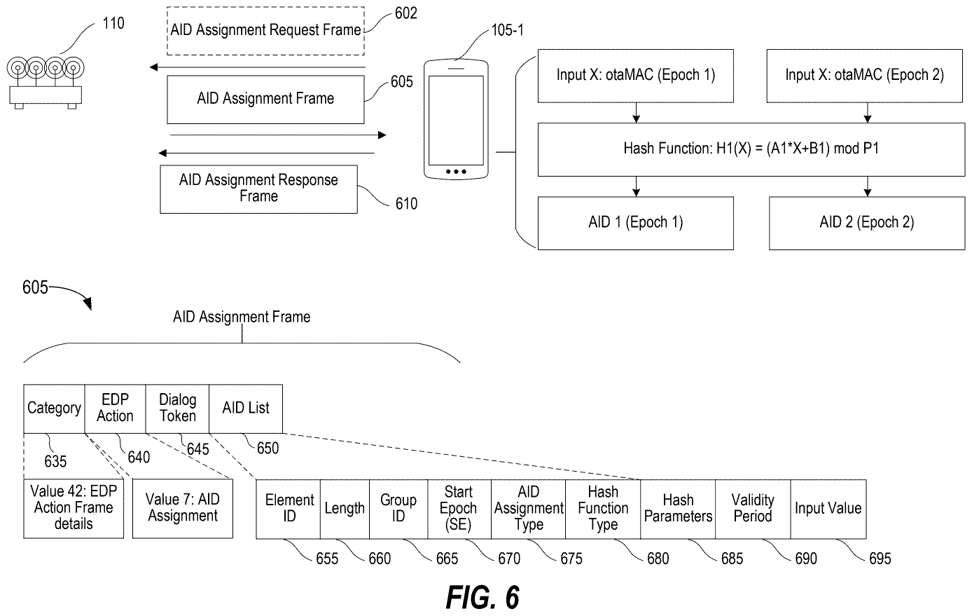

FIG. 6 depicts an example AID Assignment frame 605 including hash function parameters for AID computation, according to some embodiments of the present disclosure.

Instead of sending pre-generated AIDs in the AID Assignment frame as depicted in FIG. 1, in FIG. 6, the AP 110 transmits the type of hash function and relevant parameters to the connected STAs 105. Using these parameters, each STA computes its own AID locally based on an input. This approach allows AIDs to be generated dynamically while preventing direct exposure of AID values over the air.

The hash function used for AID computation can be represented as follows:

H(x)=(A×X+B)mod P

In this equation, H(x) represents the computed AID assigned to the STA, and A and B are parameters shared by the AP for AID computation. X is the input value, which may be the STA's over-the-air (OTA) MAC address or another bitstring, and P is a prime number that guarantees the output H(x) remains within the valid AID range (e.g., 1-2000 in an 11-bit space).

By using this function, the STA 105 can independently compute its AIDs based on the provided parameters. However, when the AP 110 connects to multiple STAs, this hash function-based AID generation method may introduce a significant overhead (e.g., O(N)) in parameter sharing. To prevent collision, a perfect hash function may be used, where each STA receives a unique set of parameters. For example, STA₁ 105-1 receives {A₁, B₁, P₁}, STA₂ 105-2 (no shown in FIG. 6) receives {A₂, B₂, P₂}, and so on. Since the AP needs to distribute a different set of hash function parameters to every connected STA, the number of parameters grows linearly with the number of STAs (N), leading to increased communication overhead.

Each STA 105 uses its assigned parameters to compute AIDs dynamically across epochs. For example, STA₁ 105-1 computes its AID for each epoch using:

H₁(x)=(A₁×X+B₁)mod P₁

The x is the input that changes across each epoch. One common input x is the STA's OTA MAC addresses, which may be randomized per epoch as part of the EDP operation.

For example, if STA₁ 105-1 has an OTA MAC address in epoch 1, which is a large bitstring (up to 46 bits), this value is used as an input x in the function to compute AID for epoch 1. When epoch 2 begins, the STA₁ 105-1 updates the input x to its new OTA MAC address and recomputes the AID for epoch 2 using the same hash function. Through this process, a unique AID can be generated for each epoch.

The OTA MAC address is provided for conceptual clarity. In some embodiments, other long bitstrings may be used to further complicate the AID computation and prevent brute-force attacks. Possible input values include a random nonce generated by the AP and shared with the STA, a session key from a cryptographic handshake, or a combination of network identifiers and timestamps. The use of a long and high-entropy input can effectively prevent brute-force attacks, as an attacker would need to guess the correct input from a vast search space before being able to predict AID assignment.

In some embodiments, to further improve security, the set of hash function parameters shared with a specific STA may only be valid for a defined period of time. Once the validity period expires, the AP 110 generates and shares a new set of parameters with the STA to refresh the AID computation process. For example, if STA1 105-1 initially receives the hash function parameters {A₁, B₁, P₁}, these parameters may be valid for a duration of T epochs. When the time period T expires, the AP 110 may update the STA₁ 105-1 with a new set of parameters, for example, {A₂, B₂, P₂}, which will be used for subsequent epochs. The STA₁ 105-1 then applies the new parameter set to compute AIDs moving forward. Such periodic parameter updates prevent long-term correlation of AIDs, making it even more difficult for an adversary to track a STA over extended periods.

In some embodiments, the AID Assignment frame 605, which includes hash function parameters, may be sent proactively by the AP 110. The AP 110 may periodically broadcast (or unicast) the AID Assignment frame 605 to all connected STAs without receiving a request. In some embodiments, the AP may send the AID Assignment frame 605 in response to an AID request 602 from a specific STA 105. This approach allows STAs 105 to request parameters when needed and therefore reduces unnecessary transmissions. The reactive approach may be beneficial for power-saving STAs, which may prefer to request updated parameters only when they wake from sleep mode.

The AID Assignment frame 605 may be sent in different formats. In some embodiments, the AID Assignment frame 605 may be structured as a separate action frame. In some embodiments, the AP 110 may embed the AID assignment information within Message 4 of the EAPOL handshake process.

Upon receiving the AID Assignment frame 605, the STA 105 may send a response frame 610 to AP 110, indicating the status of the received hash function parameters. In some embodiments, the response 610 may confirm that the parameters were received and properly stored. If the STA 105 detects any inconsistencies or corruption in the received parameters, the STA may send a response frame 610 requesting retransmission or parameter correction.

As depicted, the AID Assignment frame 605 includes the following fields: a Category field 635, an EDP Action field 640, a Dialog Token field 645, and an AID List element 650. The Category field 635 identifies the frame category, indicating that this frame 605 relates to EDP operations (e.g., value 42). The EDP Action field 640 indicates the type of EDP action being requested (e.g., value 7 for AID assignment-related actions). The Dialog Token field 645 is set to a nonzero value to track request and response messages. The AID List element 650 includes the actual AID assignment details, such as the hash function parameters {A, B, P}.

As depicted, the AID List element 650 comprises multiple subfields that provide the details for AID computation. The Element ID subfield 655 identifies the type of the AID List element 650 with the frame 605. The Length subfield 660 indicates the total length of the AID List element 650. The Group ID subfield 665 specifies the EDP group to which the STA belongs. The Start Epoch (SE) subfield 670 indicates the epoch from which the hash function parameters become valid. This field is to maintain proper synchronization between the AP and STAs. The AID Assignment Type subfield 675 defines whether the AID assignment follows pre-generated AID allocation (as depicted in FIGS. 1-5) or uses a hash function-based method (as depicted in FIG. 6). The Hash Parameter subfield 685 contains the hash function parameters (e.g., A, B, P) required by STAs to compute their AIDs dynamically. The Validity Period subfield 690 defines the duration for which the assigned hash parameters remain valid. Once the validity period expires, the AP may send new parameters (e.g., A, B, P) to the STA to refresh AID assignment. The Input Value subfield 695 indicates the input that the STA uses for AID computation. The input may include the STA's OTA MAC address, a cryptographic nonce, a session key, or any other long-bitstring values.

The AID Assignment frame 605 is designed to support hash function-based computation. With the included information (e.g., hash function parameters, validity periods, and input value type), the STA may calculate AIDs for subsequent epochs dynamically and independently.

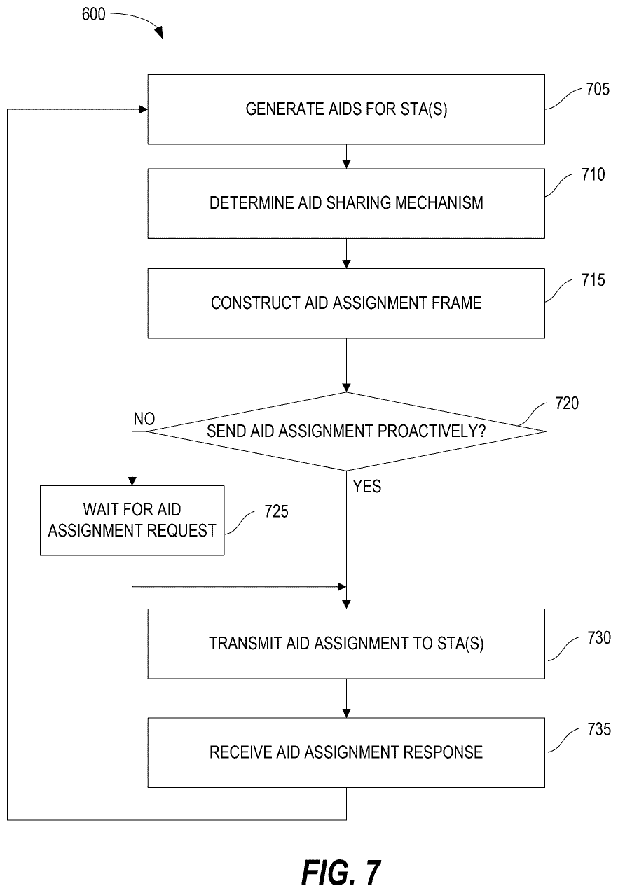

FIG. 7 depicts an example method 700 for an AP to assign AIDs to STAs using a structured AID assignment scheme based on direct AID generation, according to some embodiments of the present disclosure. In some embodiments, the method 700 may be performed by one or more network devices capable of managing AID assignment within a BSSID, such as AP 110 as depicted in FIG. 1, and 3-6.

At block 705, an AP (e.g., 110 of FIG. 1, and 3-6) generates AIDs for all associated STAs (e.g., 105 of FIG. 1, and 3-6). In one embodiment, the AP may select AIDs from the available pool following two collision-avoidance rules (as depicted in FIG. 3)—no collision of AIDs among different STAs within the same epoch (e.g., if STA₁ 105-1 is assigned AID 7, no other STAs in that epoch can be assigned AID 7), and no reuse of the same AID by a single STA across two consecutive epochs (e.g., if STA 105-1 is assigned AID 7 in epoch 1, it cannot be assigned AID 7 in epoch 2).

In another embodiment, the AP may assign AID from a defined block range for each epoch (as depicted in FIG. 4). For example, in epoch 1, AIDs may be selected from 1-100, and in epoch 2, AIDs may be selected from 101-200. This structured block allocation prevents cross-epoch AID reuse by different STAs (e.g., if STA 105-1 is assigned AID 12 in epoch 1, no STA in epoch 2 can use AID 12).

In another embodiment, the AP may establish a permutation matrix, where each column represents an epoch and each row corresponds to a specific STA (as depicted in FIG. 5). The AP may then assign AIDs from the matrix to corresponding STAs. Through this approach, AID selection provides no collisions within the same epoch (as each column is a unique permutation of AIDs) and no reuse of AIDs by different STAs across epochs (as each STA receives a distinct set of AIDs).

At block 710, the AP determines how to share the generated AIDs with STAs. The AP may choose between a full list encoding format (e.g., 205-1 of FIG. 2) or a delta encoding format (e.g., 205-2 of FIG. 2). When full list encoding is used, the AP may send the entire list of assigned AIDs to STAs. When delta encoding is applied, the AP may send only an initial AID and a sequence of delta values to STAs. Each STA may then compute subsequent AIDs incrementally using the initial AID.

At block 715, the AP constructs the AID Assignment frame (e.g., 115 of FIG. 1) to include the generated AIDs using the selected sharing format (e.g., full list or delta encoding). The frame includes the generated AID list, epoch information to indicate when the start epoch is valid, and AID format metadata.

At block 720, the AP decides whether to transmit the AID Assignment frame proactively or in response to a request. The decision may be developed considering the AP's configuration, network conditions, and other relevant operational parameters. If proactive transmission is selected, the method 700 moves to block 730, where the AP immediately sends the AID Assignment frame to all STAs. If the AP decides to transmit the AID assignment reactively, the method 700 proceeds to block 725, where the AP waits for an AID Assignment Request (e.g., 185 of FIG. 1) from an STA. Upon receiving an AID Assignment Request frame, the AP retrieves the corresponding AID assignment data. Following that, at block 730, the AP sends the data to the requesting STA.

At block 735, the AP monitors responses from STAs to verify receipt and storage of AID information. If the assigned AIDs are properly received and stored, the STA's response (e.g., 190 of FIG. 1) may include an acknowledgement confirming the successful reception, indicating that the STA is ready to use the assigned AIDs in subsequent epochs. If errors arise during reception or processing, the response may include a reason code indicating the issue. Examples of reason codes may indicate partial storage of AID list, AID assignment received too early, or AID list exceeding the STA's storage capacity. In embodiments where reception issues occur, the AP may need to adjust the parameters accordingly and/or retransmit the AID Assignment frame at a later time. Following block 735, the method 700 cycles back to block 705, where the AP generates new AIDs for the next sequence of epochs. The iterative process allows STAs to continue to receive updated AIDs in a structured and timely manner.

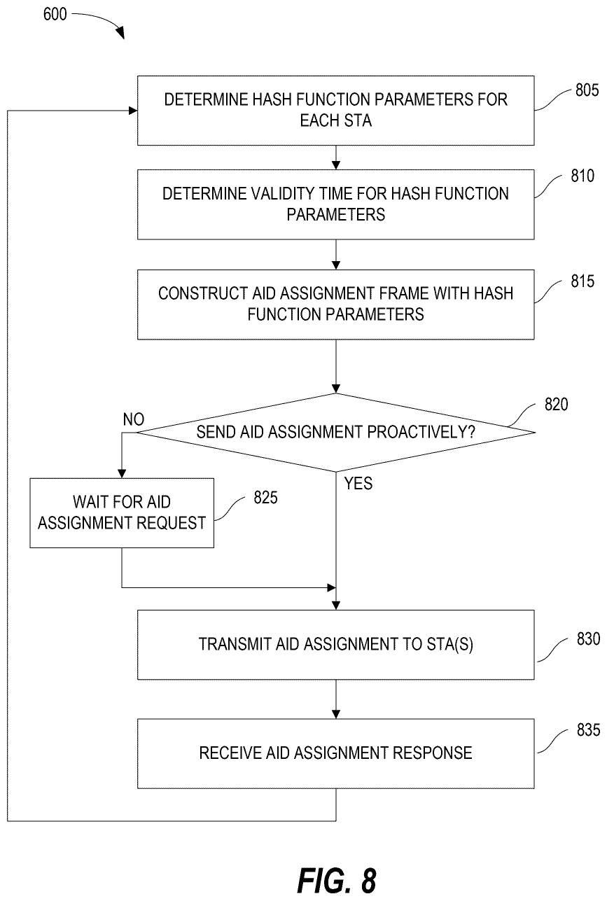

FIG. 8 depicts an example method 800 for an AP to assign AIDs to STAs using a structured AID assignment scheme based on a perfect hash function, according to some embodiments of the present disclosure. In some embodiments, the method 800 may be performed by one or more network devices capable of managing AID assignment within a BSSID, such as AP 110 as depicted in FIG. 1, and 3-6.

At block 805, an AP (e.g., 110 of FIG. 1, and 3-6) determines a set of hash function parameters (e.g., {A, B, P}) for each STA (e.g., 105 of FIG. 1, and 3-6) to compute its AIDs. To avoid AID collision, the AP may assign each STA a unique set of parameters (e.g., {A₁, B₁, P₁} for STA 1, {A₂, B₂, P₂} for STA 2). With the assigned hash function parameters, each STA may calculate its AIDs for each subsequent epoch by applying the hash function. As discussed above, the input (x) used in the hash function may include the STA's OTA MAC address (which is up to 64 bits and changes per epoch, as part of EDP operation), a session key from authentication or key exchange protocols, a cryptographic nonce shared between the AP and the STA, or a combination of timestamps and network-specific identifiers. The use of a high-entropy input value maintains the AID computation as dynamic and resistant to brute-force attacks.

At block 810, the AP determines how long a given set of hash function parameters remain valid before requiring an update. The validity time may include a fixed update interval (e.g., every N epochs), and be determined based on security policies or any STA-specific requirements.

At block 815, the AP constructs the AID Assignment frame (e.g., 605 of FIG. 6). The AID Assignment frame indicates the hash function type, the parameters (A, B, P) assigned to each STA, the validity period indicating when the parameters expire, and the expected input value (e.g., OTA MAC address, cryptographic nonce, session key, or timestamp).

At block 820, the AP decides whether to send the AID Assignment frame proactively (broadcasting to all connected STAs without receiving a request) or wait for an STA request. The determination may be based on the AP's configuration, network conditions, security policies, and other relevant operational factors. If proactive transmission is selected, the method 800 moves to block 830, where the AP immediately sends the AID Assignment frame to all STAs. If reactive transmission is determined, the method 800 proceeds to block 825, where the AP waits for an AID Assignment Request frame (e.g., 602 of FIG. 6) from an STA. Upon receiving a request, at block 830, the AP transmits the parameters to the requesting STA.

At block 835, the AP monitors STA responses (e.g., 610 of FIG. 6) to verify that the parameters are received and stored correctly. If parameters are received and stored successfully, the response includes an acknowledgement of the reception. If issues occur, the response may include an error code or reason code, indicating problems such as parameter storage failure due to insufficient memory, invalid parameter values, and parameters received too early (e.g., STA is not ready for an update). If an issue arises, the AP may need to adjust the parameters accordingly and/or retransmit the AID Assignment frame at a later time.

Following block 835, the method 800 returns back to block 805, where the AP generates and distributes new hash function parameters as needed. The iterative process updates AID computation periodically to prevent long-term tracking.

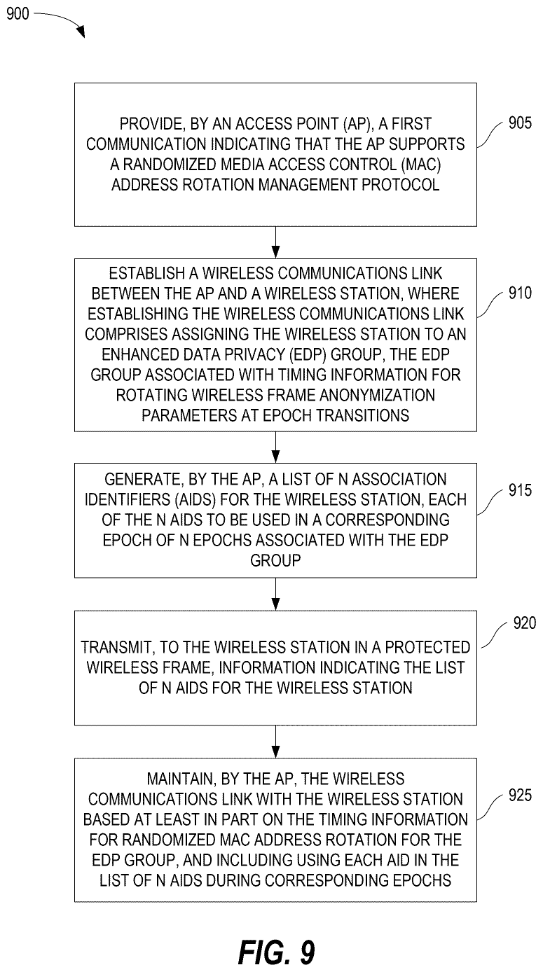

FIG. 9 is a flow diagram depicting an example method 900 for AID generation and assignment, according to some embodiments of the present disclosure.

At block 905, an AP (e.g., AP 110 of FIG. 1, and 3-6) provides a first communication indicating that the AP supports a randomized Media Access Control (MAC) address rotation management protocol.

At block 910, the AP establishes a wireless communications link between the AP and a wireless station (e.g., STA 105 of FIG. 1, and 3-6), where establishing the wireless communications link comprises assigning the wireless station to an Enhanced Data Privacy (EDP) group, the EDP group associated with timing information for rotating wireless frame anonymization parameters at epoch transitions.

At block 915, the AP generates a list of N association identifiers (AIDs) for the wireless station, each of the N AIDs to be used in a corresponding epoch of N epochs associated with the EDP group.

At block 920, the AP transmits, to the wireless station in a protected wireless frame, information indicating the list of N AIDs for the wireless station.

At block 925, the AP maintains, by the AP, the wireless communications link with the wireless station based at least in part on the timing information for randomized MAC address rotation for the EDP group, and including using each AID in the list of N AIDs during corresponding epochs.

In some embodiments, the AIDs in the list of N AIDs may be assigned from a preexisting range of AIDs.

In some embodiments, each AID in the list of N AIDs may be to be used in a corresponding epoch of a set of future, consecutive epochs (e.g., 125 of FIG. 1).

In some embodiments, each AID in the list of N AIDs may be unique to the wireless station during an epoch corresponding to the AID.

In some embodiments, the AP may transmit one or more wireless frames between the AP and the wireless station to negotiate the EDP group the EDP group assigned to the wireless station.

In some embodiments, the transmitting one or more wireless frames between the AP and the wireless station to negotiate the EDP group may comprise receiving, by the AP, one or more wireless frames including time scheduling information for randomized MAC address information requested by the wireless station, and transmitting, by the AP, a response to the one or more wireless frames indicating acceptance of the time scheduling information requested by the wireless station.

In some embodiments, before an end of the N epochs, the AP may generate a second list of N association identifiers (AIDs) for the wireless station, each of the N AIDs to be used in a corresponding second epoch of N second epochs associated with the EDP group, and transmit to the wireless station in a second protected wireless frame, information indicating the second list of N AIDs for the wireless station.

In some embodiments, the list of N AIDs may comprise a first AID as a first entry in the list, and a delta value for a second entry in the list of N AIDs, the delta value expressing a difference between the first entry in the list and the second entry.

In some embodiments, the protected wireless frame indicating the list of N AIDs may be an encrypted wireless action frame.

In some embodiments, protected wireless frame indicating the list of N AIDs may be an Extensible Authentication Protocol over LAN (EAPoL) M4 message.

In some embodiments, the AP may receive a wireless frame indicating a request for a new list of AIDs.

In some embodiments, the wireless frame indicating the request for a new list of AIDs may further identify one or more epochs corresponding to the new list of AIDs.

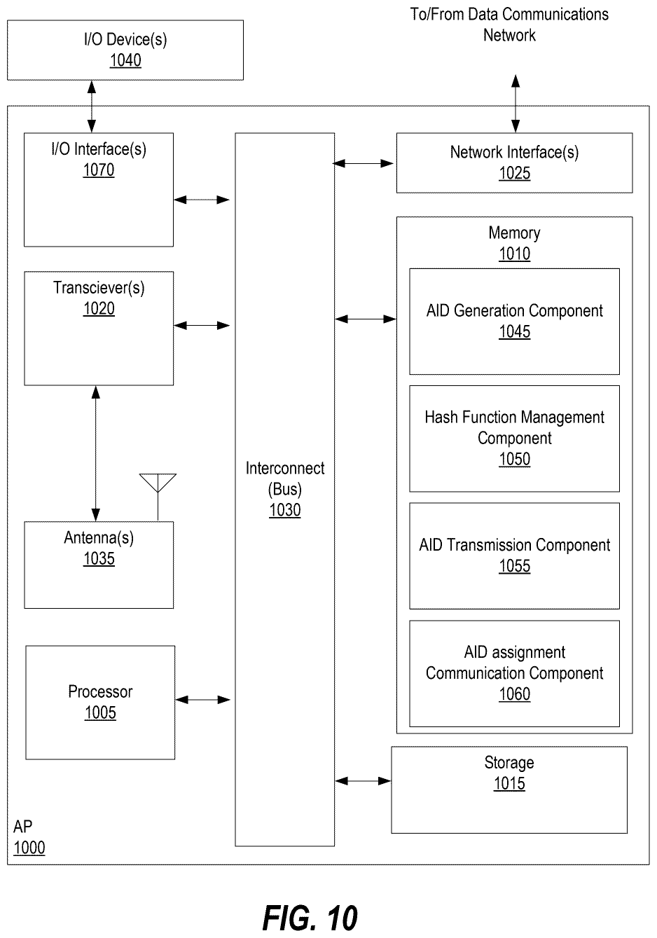

FIG. 10 depicts an example network device 1000 configured to perform various aspects of the present disclosure, according to some aspects of the present disclosure. The network device 100 may be an AP, which corresponds to AP 110 as depicted in FIG. 1, and 3-6.

As illustrated, the example network device 1000 includes a processor 1005, memory 1010, storage 1015, one or more transceivers 1020, one or more I/O interfaces 1080, and one or more network interfaces 1025. In some embodiments, I/O devices 1040 are connected via the I/O interface(s) 1080. Further, via the network interface 1025, the network device 1000 can be communicatively coupled with one or more other devices and components (e.g., via a network, which may include the Internet, local network(s), and the like). Each of the components is communicatively coupled by one or more buses 1030. In some embodiments, one or more antennas 1035 may be coupled to the transceivers 1020 for transmitting and receiving wireless signals.

The processor 1005 is generally representative of a single central processing unit (CPU) and/or graphic processing unit (GPU), multiple CPUs and/or GPUs, a microcontroller, an application-specific integrated circuit (ASIC), or a programmable logic device (PLD), among others. The processor 1005 processes information received through the transceiver 1020, I/O interfaces 1080, and the network interfaces 1025. The processor 1005 retrieves and executes programming instructions stored in memory 1010, as well as stores and retrieves application data residing in storage 1015.

The storage 1015 may be any combination of disk drives, flash-based storage devices, and the like, and may include fixed and/or removable storage devices, such as fixed disk drives, removable memory cards, caches, optical storage, network attached storage (NAS), or storage area networks (SAN). The storage 1015 may store a variety of data for the efficient functioning of the system.

The memory 1010 may include random access memory (RAM) and read-only memory (ROM). The memory 1010 may store processor-executable software code containing instructions that, when executed by the processor 1005, enable the network device 1000 to perform various functions described herein for wireless communication. In the illustrated example, the memory 1010 includes four software components: the AID generation component 1045, the hash function management component 1050, the AID transmission component 1055, and the AID assignment communication component 1060.

In one embodiment, the AID assignment component 1045 is configured to manage the allocation of AIDs to connected STAs. In one embodiment, the AID assignment component 1045 assigns AIDs directly from the available pool, following two no-collision rules—no AID collision among different STAs within the same epoch and no reuse of the same AID by the same STA across consecutive epochs. In one embodiment, the AID assignment component 1045 allocates AIDs from predefined block ranges, where each epoch is assigned a different range of AID values. The block-based approach prevents AID reuse across consecutive epochs by different STAs, and therefore further improves privacy and mitigates TIM-related issues. In one embodiment, the AID assignment component 1045 generates a permutation matrix where each column represents an epoch, and each row corresponds to a specific STA. This structure provides no intro-epoch collisions and prevents cross-epoch reuse by different STAs.

In one embodiment, the hash function management component 1050 is configured to generate and manage hash function parameters for AID computation by STAs. More specifically, the hash function management component 1050 computes STA-specific parameters (A, B, P) for the hash function, determines validity periods for parameter use, and specifies the high-entropy inputs (e.g., OTA MAC address, session key) used in the hash function.

In one embodiment, the AID transmission component 1055 is configured to determine how AID-related information is transmitted to STAs, including frame construction, transmission policy, and sharing format (e.g., full list encoding or delta encoding). When AIDs are generated and assigned directly by the network device 1000, the AID transmission component 1055 selects the sharing format based on network conditions and STA processing capability. The two sharing formats include the full list encoding (transmitting all AIDs at once) and the delta encoding (transmitting an initial AID with incremental updates). Upon determining the format, the AID transmission component 1055 constructs the AID Assignment frame to include the AID list, epoch information, and metadata specifying the encoding type and assignment strategy. In embodiments where the AP assigns hash function parameters, the AID transmission component 1055 includes the hash function parameters, validity period, and input datatype into the assignment frame.

In one embodiment, the AID assignment communication component 1060 manages communications between the network device (AP) 1000 and the STAs. More specifically, the AID assignment communication component 1060 monitors STA responses to verify successful reception and storage of assigned AIDs or hash function parameters. When errors are detected in reception and application, such as incorrect storage or transmission timing issues, the AID assignment communication component 1060 manages retransmission of AID Assignment frames when needed.

To facilitate understanding, identical reference numerals have been used, where possible, to designate identical elements that are common to the figures. It is contemplated that elements disclosed in one embodiment may be beneficially used in other embodiments without specific recitation.

Although depicted as a discrete component for conceptual clarity, in some embodiments, the operations of the depicted components (and others not illustrated) may be combined or distributed across any number of components. Further, although depicted as software residing in memory 1010, in some aspects, the operations of the depicted components (and others not illustrated) may be implemented using hardware, software, or a combination of hardware and software.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

### EXAMPLE CLAUSES

Implementation examples are described in the following numbered clauses:

Clause 1: A method, comprising: generating, by an access point (AP), a set of association identifiers (AIDs) for a plurality of stations (STAs) connected to the AP in a wireless network, wherein each respective STA is assigned a respective AID within an epoch according to a structured AID assignment scheme; determining, by the AP, an AID sharing mechanism to transmit a list of assigned AIDs to a first STA among the plurality of STAs, wherein the first STA applies the assigned AIDs in one or more subsequent epochs; and transmitting, by the AP to the first STA, an AID assignment frame comprising the list of assigned AIDs.

Clause 2: The method of Clause 1, wherein transmitting the AID assignment frame comprising the list of assigned AIDs comprises: receiving, by the AP, an AID assignment request frame from the respective STA; and in response to the AID assignment request frame, transmitting, by the AP to the respective STA, the AID assignment frame comprising the list of assigned AIDs.

Clause 3. The method of Clause 1, wherein the structured AID assignment scheme comprises: assigning, by the AP, a first AID to a respective STA, among the plurality of STAs, from a first range of AID values, wherein the first AID is used by the respective STA in a first subsequent epoch; and assigning, by the AP, a second AID to the respective STA, from a second range of AID values, wherein the second AID is used by the respective STA in a second subsequent epoch, the second epoch immediately following the first epoch, and the first range of AID value does not overlap with the second range of AID values.

Clause 4: The method of Clause 1, wherein the structured AID assignment scheme comprises: generating, by the AP, a matrix comprising a plurality of columns and rows, wherein each column corresponds to an epoch, and each row corresponds to a respective STA among the plurality of STAs; populating, by the AP, each column with a permutation of AID values, wherein each STA within a column is assigned a unique AID; adjusting, by the AP, the permutation of AID values across epochs to prevent AID reuse within consecutive epochs; and assigning, by the AP, to each respective STA among the plurality of STAs, a list of AIDs based on corresponding row in the matrix.

Clause 5: The method of Clause 1, further comprising: generating, by the AP, a perfect hash function to map the plurality of STAs to the set of AIDs within a predefined range; and transmitting, by the AP to each respective STA among the plurality of STAs, a set of parameters associated with the perfect hash function, wherein the set of parameters are used by each respective STA to compute an assigned AID for each of the one or more subsequent epochs.

Clause 6: The method of Clause 1, wherein the AID sharing mechanism comprises: transmitting, by the AP, a full list of the assigned AIDs to the respective STA.

Clause 7: The method of Clause 1, wherein the AID sharing mechanism comprises: transmitting, by the AP to the respective STA, an initial AID within the list of assigned AIDs and a sequence of delta values, wherein each delta value represents an offset from a previously assigned AID for use in the one or more subsequent epochs.

Clause 8: The method of Clause 1, wherein the AID assignment frame is transmitted as one of an action frame, or an extensible authentication protocol over local area network (LAN) (EAPOL) message 4 of a 4-way handshake process.

Clause 9: A system of an access point (AP), comprising: one or more computer processors; and one or more memories collectively containing one or more programs, which, when executed by the one or more computer processors, perform an operation, the operation comprising: generating a set of association identifiers (AIDs) for a plurality of stations (STAs) connected to the AP in a wireless network, wherein each STA is assigned a unique AID within an epoch according to a structured AID assignment scheme; determining an AID sharing mechanism to transmit a list of assigned AIDs to a respective STA among the plurality of STAs, wherein the respective STA applies the assigned AIDs in one or more subsequent epochs; and transmitting, to the respective STA, an AID assignment frame comprising the list of assigned AIDs.

Clause 10: The system of Clause 9, wherein transmitting the AID assignment frame comprising the list of assigned AIDs comprises: receiving an AID assignment request frame from the respective STA; and in response to the AID assignment request frame, transmitting, to the respective STA, the AID assignment frame comprising the list of assigned AIDs.

Clause 11: The system of Clause 9, wherein the structured AID assignment scheme comprises: assigning a first AID to a respective STA, among the plurality of STAs, from a first range of AID values, wherein the first AID is used by the respective STA in a first subsequent epoch; and assigning a second AID to the respective STA, from a second range of AID values, wherein the second AID is used by the respective STA in a second subsequent epoch, the second epoch immediately following the first epoch, and the first range of AID value does not overlap with the second range of AID values.

Clause 12: The system of Clause 9, wherein the structured AID assignment scheme comprises: generating a matrix comprising a plurality of columns and rows, wherein each column corresponds to an epoch, and each row corresponds to a respective STA among the plurality of STAs; populating each column with a permutation of AID values, wherein each STA within a column is assigned a unique AID; adjusting the permutation of AID values across epochs to prevent AID reuse within consecutive epochs; and assigning to each respective STA among the plurality of STAs, a list of AIDs based on corresponding row in the matrix.

Clause 13: The system of Clause 9, wherein the operation further comprises: generating a perfect hash function to map the plurality of STAs to the set of AIDs within a predefined range; and transmitting, to each respective STA among the plurality of STAs, a set of parameters associated with the perfect hash function, wherein the set of parameters are used by each respective STA to compute an assigned AID for each of the one or more subsequent epochs.

Clause 14: The system of Clause 9, wherein the AID sharing mechanism comprises: transmitting a full list of the assigned AIDs to the respective STA.

Clause 15: The system of Clause 9, wherein the AID sharing mechanism comprises: transmitting, to the respective STA, an initial AID within the list of assigned AIDs and a sequence of delta values, wherein each delta value represents an offset from a previously assigned AID for use in the one or more subsequent epochs.

Clause 16: The system of Clause 9, wherein the AID assignment frame is transmitted as one of an action frame, or an extensible authentication protocol over local area network (LAN) (EAPOL) message 4 of a 4-way handshake process.

Clause 17: One or more computer-readable media containing, in any combination, computer program code that, when executed by a computer system, performs an operation comprising: generating, by an access point (AP), a set of association identifiers (AIDs) for a plurality of stations (STAs) connected to the AP in a wireless network, wherein each STA is assigned a unique AID within an epoch according to a structured AID assignment scheme; determining, by the AP, an AID sharing mechanism to transmit a list of assigned AIDs to a respective STA among the plurality of STAs, wherein the respective STA applies the assigned AIDs in one or more subsequent epochs; and transmitting, by the AP to the respective STA, an AID assignment frame comprising the list of assigned AIDs.

Clause 18: The one or more computer-readable media of Clause 17, wherein transmitting the AID assignment frame comprising the list of assigned AIDs comprises: receiving, by the AP, an AID assignment request frame from the respective STA; and in response to the AID assignment request frame, transmitting, by the AP to the respective STA, the AID assignment frame comprising the list of assigned AIDs.

Clause 19: The one or more computer-readable media of Clause 17, wherein the structured AID assignment scheme comprises: assigning, by the AP, a first AID to a respective STA, among the plurality of STAs, from a first range of AID values, wherein the first AID is used by the respective STA in a first subsequent epoch; and assigning, by the AP, a second AID to the respective STA, from a second range of AID values, wherein the second AID is used by the respective STA in a second subsequent epoch, the second epoch immediately following the first epoch, and the first range of AID value does not overlap with the second range of AID values.

Clause 20: The one or more computer-readable media of Clause 17, wherein the structured AID assignment scheme comprises: generating, by the AP, a matrix comprising a plurality of columns and rows, wherein each column corresponds to an epoch, and each row corresponds to a respective STA among the plurality of STAs; populating, by the AP, each column with a permutation of AID values, wherein each STA within a column is assigned a unique AID; adjusting, by the AP, the permutation of AID values across epochs to prevent AID reuse within consecutive epochs; and assigning, by the AP, to each respective STA among the plurality of STAs, a list of AIDs based on corresponding row in the matrix.

We claim:

1. A method, comprising:
providing, by an access point (AP), a first communication indicating that the AP supports a randomized Media Access Control (MAC) address rotation management protocol;
establishing a wireless communications link between the AP and a wireless station, wherein establishing the wireless communications link comprises assigning the wireless station to an Enhanced Data Privacy (EDP) group, the EDP group associated with timing information for rotating wireless frame anonymization parameters at epoch transitions;
generating, by the AP, a list of N association identifiers (AIDs) for the wireless station, each of the N AIDs to be used in a corresponding epoch of N epochs associated with the EDP group;
transmitting, to the wireless station in a protected wireless frame, information indicating the list of N AIDs for the wireless station; and
maintaining, by the AP, the wireless communications link with the wireless station based at least in part on the timing information for randomized MAC address rotation for the EDP group, and including using each AID in the list of N AIDs during corresponding epochs.

2. The method of claim 1, wherein the AIDs in the list of N AIDs is assigned from a preexisting range of AIDs.

3. The method of claim 1, wherein each AID in the list of N AIDs is to be used in a corresponding epoch of a set of future, consecutive epochs.

4. The method of claim 1, wherein each AID in the list of N AIDs is unique to the wireless station during an epoch corresponding to the AID.

5. The method of claim 1, further comprising transmitting one or more wireless frames between the AP and the wireless station to negotiate the EDP group the EDP group assigned to the wireless station.

6. The method of claim 5, wherein the transmitting one or more wireless frames between the AP and the wireless station to negotiate the EDP group comprises:
receiving, by the AP, one or more wireless frames including time scheduling information for randomized MAC address information requested by the wireless station; and
transmitting, by the AP, a response to the one or more wireless frames indicating acceptance of the time scheduling information requested by the wireless station.

7. The method of claim 1, further comprising, before an end of the N epochs:
generating, by the AP, a second list of N association identifiers (AIDs) for the wireless station, each of the N AIDs to be used in a corresponding second epoch of N second epochs associated with the EDP group; and
transmitting, to the wireless station in a second protected wireless frame, information indicating the second list of N AIDs for the wireless station.

8. The method of claim 1, wherein the list of N AIDs comprises a first AID as a first entry in the list, and a delta value for a second entry in the list of N AIDs, the delta value expressing a difference between the first entry in the list and the second entry.

9. The method of claim 1, wherein the protected wireless frame indicating the list of N AIDs is an encrypted wireless action frame.

10. The method of claim 1, wherein protected wireless frame indicating the list of N AIDs is an Extensible Authentication Protocol over LAN (EAPoL) M4 message.

11. The method of claim 1, further comprising receiving, by the AP, a wireless frame indicating a request for a new list of AIDs.

12. The method of claim 11, wherein the wireless frame indicating the request for a new list of AIDs further identifies one or more epochs corresponding to the new list of AIDs.

13. A wireless access point (AP) comprising:
at least one memory element for storing data; and
at least one processor for executing instructions associated with the data, wherein executing the instructions causes the wireless AP to perform operations, comprising:
providing, by the AP, a first communication indicating that the AP supports a randomized Media Access Control (MAC) address rotation management protocol;
establishing a wireless communications link between the AP and a wireless station, wherein establishing the wireless communications link comprises assigning the wireless station to an Enhanced Data Privacy (EDP) group, the EDP group associated with timing information for rotating wireless frame anonymization parameters at epoch transitions;
generating, by the AP, a list of N association identifiers (AIDs) for the wireless station, each of the N AIDs to be used in a corresponding epoch of N epochs associated with the EDP group;
transmitting, to the wireless station in a protected wireless frame, information indicating the list of N AIDs for the wireless station; and
maintaining, by the AP, the wireless communications link with the wireless station based at least in part on the timing information for randomized MAC address rotation for the EDP group, and including using each AID in the list of N AIDs during corresponding epochs.

14. The wireless AP of claim 13, wherein the AIDs in the list of N AIDs is assigned from a preexisting range of AIDs.

15. The wireless AP of claim 13, wherein each AID in the list of N AIDs is to be used in a corresponding epoch of a set of future, consecutive epochs.

16. The wireless AP of claim 13, wherein each AID in the list of N AIDs is unique to the wireless station during an epoch corresponding to the AID.

17. The wireless AP of claim 13, the operations further comprising transmitting one or more wireless frames between the AP and the wireless station to negotiate the EDP group the EDP group assigned to the wireless station.

18. The wireless AP of claim 17, wherein the transmitting one or more wireless frames between the AP and the wireless station to negotiate the EDP group comprises:
receiving, by the AP, one or more wireless frames including time scheduling information for randomized MAC address information requested by the wireless station; and
transmitting, by the AP, a response to the one or more wireless frames indicating acceptance of the time scheduling information requested by the wireless station.

19. The wireless AP of claim 13, the operations further comprising, before an end of the N epochs:
generating, by the AP, a second list of N association identifiers (AIDs) for the wireless station, each of the N AIDs to be used in a corresponding second epoch of N second epochs associated with the EDP group; and
transmitting, to the wireless station in a second protected wireless frame, information indicating the second list of N AIDs for the wireless station.

20. The wireless AP of claim 13, wherein the list of N AIDs comprises a first AID as a first entry in the list, and a delta value for a second entry in the list of N AIDs, the delta value expressing a difference between the first entry in the list and the second entry.

21. The wireless AP of claim 13, wherein the protected wireless frame indicating the list of N AIDs is an encrypted wireless action frame.

22. The wireless AP of claim 13, wherein protected wireless frame indicating the list of N AIDs is an Extensible Authentication Protocol over LAN (EAPoL) M4 message.

23. The wireless AP of claim 13, the operations further comprising receiving, by the AP, a wireless frame indicating a request for a new list of AIDs.

24. The wireless AP of claim 23, wherein the wireless frame indicating the request for a new list of AIDs further identifies one or more epochs corresponding to the new list of AIDs.

25. A non-transitory computer readable storage medium comprising instructions that when executed configure one or more processors of a wireless access point (AP) to perform operations comprising:
providing, by the AP, a first communication indicating that the AP supports a randomized Media Access Control (MAC) address rotation management protocol;
establishing a wireless communications link between the AP and a wireless station, wherein establishing the wireless communications link comprises assigning the wireless station to an Enhanced Data Privacy (EDP) group, the EDP group associated with timing information for rotating wireless frame anonymization parameters at epoch transitions;
generating, by the AP, a list of N association identifiers (AIDs) for the wireless station, each of the N AIDs to be used in a corresponding epoch of N epochs associated with the EDP group;
transmitting, to the wireless station in a protected wireless frame, information indicating the list of N AIDs for the wireless station; and
maintaining, by the AP, the wireless communications link with the wireless station based at least in part on the timing information for randomized MAC address rotation for the EDP group, and including using each AID in the list of N AIDs during corresponding epochs.
